(19) United States
(12) Patent Application Publication
(10) Pub. No.: US 2025/0003181 A1
(43) Pub. Date: Jan. 2, 2025

(54) ELECTRIC POWER PACK FOR POWER MACHINE

(71) Applicant: Doosan Bobcat North America Inc, West Fargo, ND (US)

(72) Inventors: Ondrej Dufala, Prague 5- Zbraslav (CZ); Bohuslav Vasicek, Prague 9 - Hrdlorezy (CZ); Petr Kratochvil, Prague (CZ)

(21) Appl. No.: 18/643,286

(22) Filed: Apr. 23, 2024

Related U.S. Application Data
(60) Provisional application No. 63/524,510, filed on Jun. 30, 2023.

(51) Int. Cl. E02F 3/96; B60L 50/60; B60L 58/26; E02F 9/08; E02F 9/16; E02F 9/22; H01M 10/613; H01M 10/625; H01M 10/6563; H01M 50/204; H01M 50/249

(52) U.S. Cl. CPC E02F 3/964; B60L 50/66; B60L 58/26; E02F 9/0866; E02F 9/16; E02F 9/226; H01M 10/613; H01M 10/625; H01M 10/6563; H01M 50/204; H01M 50/249; B60L 2200/40; H01M 2220/20

(57) ABSTRACT

Disclosed power machines have a frame with an upper frame portion which swivels relative to a lower frame portion. An electric motor powers a hydraulic system to power hydraulic actuators on the machine. A battery pack support structure mounted on the upper frame portion is configured to mount at least first, second and third battery packs at multiple vertical levels and in a staggered or wrap-around configuration around the electric motor.

### CROSS-REFERENCE TO RELATED APPLICATION(S)

This application claims the benefit of U.S. provisional application No. 63/524,510, filed on Jun. 30, 2023, the content of which is hereby incorporated by reference in its entirety.

### BACKGROUND

This disclosure is directed toward power machines. More particularly, this disclosure is directed to power machines, such as excavators, having an electric power source.

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include excavators, loaders, utility vehicles, tractors, and trenchers, to name a few examples.

In work vehicles such as excavators, to power the various movements of the vehicle, or have functionality of powered implements, a hydraulic system is commonly used to provide pressurized hydraulic fluid to the actuator of each function. Conventionally, the hydraulic systems of work vehicles have been powered using internal combustion engines as the power source. However, increasingly, there are efforts to produce work vehicles which utilize batteries as the primary power source. The batteries are used to power electric actuators, such as an electric motor. The electric motor can be used to power a hydraulic system, which in turn powers hydraulic actuators. Alternatively, the hydraulic system can in some instances be replaced with additional electric actuators to perform the various work functions. Placement of battery packs, electric chargers, electric motors, corresponding hydraulic pump packages, and other components in an electric powered work vehicle can be challenging given limited space available, particularly in conventionally shaped and sized machines.

The discussion above is merely provided for general background information and is not intended to be used as an aid in determining the scope of the claimed subject matter.

### SUMMARY

Disclosed embodiments are directed to excavators and power machines with an electric power source which powers an electric motor to in turn power a hydraulic pump and system. Exemplary embodiments are directed to power machines having a frame with an upper frame portion which swivels relative to a lower frame portion. The electric motor powers the hydraulic system to power hydraulic actuators on the machine. A battery pack support structure mounted on the upper frame portion is configured to mount at least first, second and third battery packs at multiple vertical levels and in a staggered or wrap-around configuration around the electric motor.

In a first embodiment, the battery pack support structure mounted on the upper frame portion is configured to mount first, second and third battery packs on battery support surfaces in a staggered configuration around the electric motor. In this configuration, the first battery pack is positioned rearward of the electric motor on a first battery support surface at a first vertical level. The second battery pack is positioned rearward of the electric motor on a second battery support surface at a second vertical level above the first battery pack. The third battery pack is positioned on a third battery support surface above the electric motor at a third vertical level above the first battery support surface and below the second battery support surface.

In a second embodiment, the battery pack support structure mounted on the upper frame portion is configured to mount at least first, second and third battery packs in a configuration around the electric motor. In this configuration, the first battery pack is positioned at a rear of the upper frame portion at a first vertical level and rearward of the electric motor. The second battery pack is positioned at a rear of the upper frame portion at a second vertical level above the first battery pack and rearward of the electric motor. The third battery pack positioned on a first side of the upper frame portion such that the first and third battery packs wrap from rearward of the electric motor to the side of the electric motor.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating functional systems of a representative power machine on which embodiments of the present disclosure can be practiced.

FIG. 2 is a front left perspective view of a representative power machine in the form of an excavator on which the disclosed embodiments can be practiced.

FIG. 3 is a rear right perspective view of the excavator of FIG. 2.

FIG. 4 is a rear perspective view of a partially assembled excavator illustrating a first exemplary electric battery pack mounting configuration.

FIG. 5 is a rear perspective view of the excavator shown in FIG. 4 and illustrating a battery pack mount bracket assembly (hereinafter the bracket assembly), the battery pack configuration, and a hydraulic cooling system in greater detail.

FIG. 6 is a front perspective view of a portion (main battery pack weldment) of the bracket assembly shown in FIG. 4.

FIG. 7 is a front perspective view of the bracket assembly and battery pack configuration of the excavator shown in FIG. 4.

FIGS. 8-9 are illustrations of placements of an electric motor, a hydraulic pump package, and an inverter relative to the bracket assembly and battery pack configuration in the excavator shown in FIG. 4.

FIG. 10 is a rear perspective view of the excavator shown in FIG. 4 and illustrating charger and hydraulic heat exchanger along with the fan positioning in relation to the bracket assembly and batteries.

FIG. 11 is a rear perspective view of a portion of an excavator illustrating a second exemplary electric battery pack mounting configuration.

FIGS. 12-13 are front perspective views of the excavator and electric battery pack configuration shown in FIG. 11.

FIG. 14 is a perspective view of a supportive structure or frame which supports an electric motor and inverter of the excavator.

FIGS. 15-16 are rear perspective views of a frame of the excavator shown in FIG. 10 and illustrating a platform for mounting the electric batteries and electric motor.

FIG. 17 is a rear perspective view of the excavator shown in FIG. 11 and illustrating battery pack removal directions.

FIG. 18 is a rear perspective view of the excavator shown in FIG. 11 and illustrating electric motor and charger removal directions.

FIGS. 19-21 are perspective views illustrating machine configurations providing cooling airflow for electric components.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Disclosed embodiments are directed to power machines, such as excavators, which utilize battery packs and an electric motor as a power source for powering machine actuators such as drive motors, lift arm functions, implement functions, etc. The power machines can utilize electric actuators, and/or can include a hydraulic pump driven by an electric motor to power hydraulic actuators. For example, battery powered excavators can have hydraulic systems to perform major functions. These types of excavators have one or more battery packs that power an electric motor, which in turn powers the hydraulic system. Disclosed embodiments provide improved mounting configurations for mounting electric power source components, including battery packs, an inverter, chargers, and an electric motor, into the limited space available in an excavator.

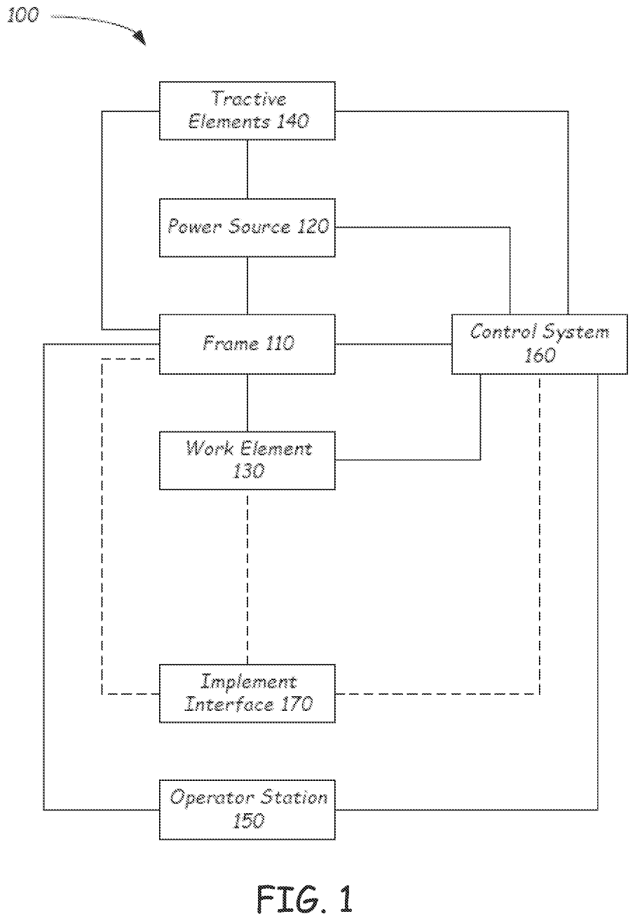

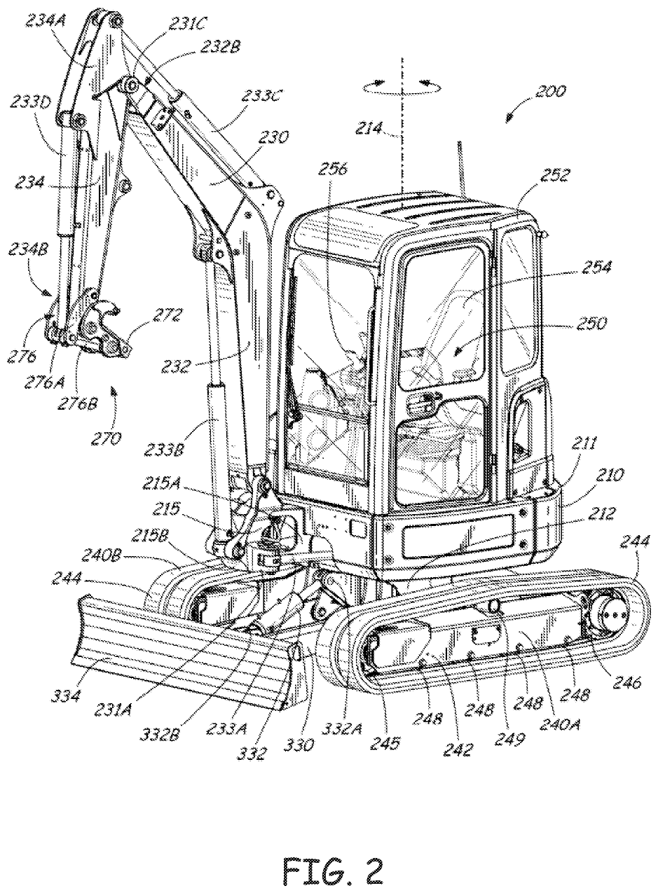

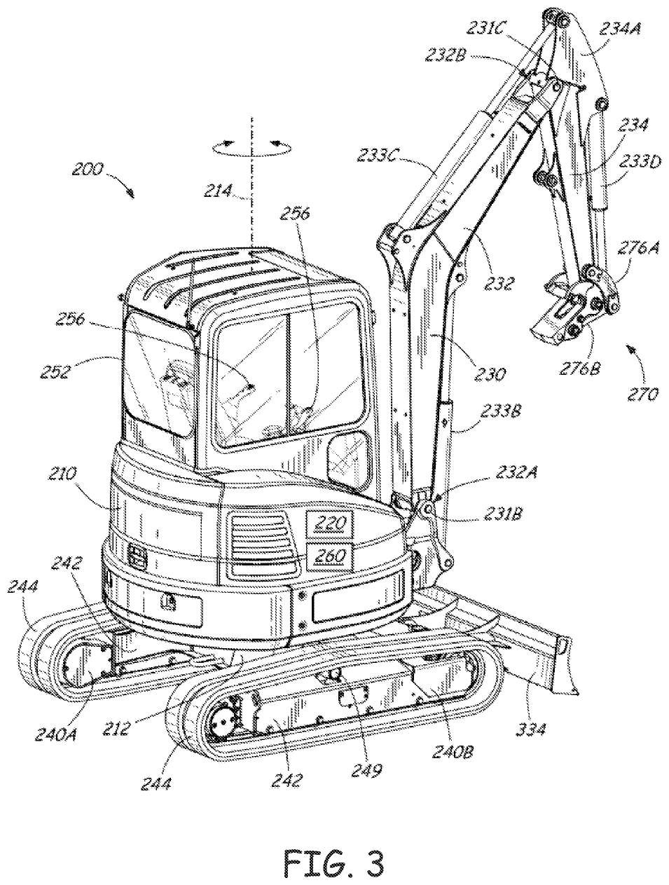

These concepts can be practiced on various power machines, as will be described below. A representative power machine on which the embodiments can be practiced is illustrated in diagram form in FIG. 1 and examples of such a power machine are illustrated in FIGS. 2-3 and described below before any embodiments are disclosed. For the sake of brevity, only a few power machines are discussed. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that is capable of providing power to the work element to accomplish a work task. One type of power machine is a self-propelled work vehicle. Self-propelled work vehicles are a class of power machines that include a frame, work element, and a power source that is capable of providing power to the work element. At least one of the work elements is a motive system for moving the power machine under power.

Referring now to FIG. 1, a block diagram illustrates the basic systems of a power machine 100 upon which the embodiments discussed below can be advantageously incorporated and can be any of a number of different types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that are capable of performing a dedicated task. For example, some work vehicles have a lift arm to which an implement such as a bucket is attached such as by a pinning arrangement. The work element, i.e., the lift arm can be manipulated to position the implement for performing the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that is capable of moving with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is capable of providing power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. In exemplary embodiments, power source 120 includes an electrical power source or a combination of power sources, known generally as hybrid power sources. As discussed, the power source includes one or more battery packs. The power source typically also includes power conversion components such as an electric motor powered by the battery packs. In some exemplary embodiments, such power conversion components also include one or more hydraulic pumps powered by the electric motor to provide pressurized hydraulic fluid for a hydraulic system including hydraulic actuators. In alternative embodiments, no hydraulic system is included and all actuators on the power machine are electric actuators. In yet other specific embodiments, the power machine may include a combination of electric actuators that power tractive elements and/or elements of a work group (e.g., slew motor), and an electric motor that powers a hydraulic pump to provide pressurized hydraulic fluid for one or more hydraulic actuators of the workgroup and/or tractive elements.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be rigidly mounted to the frame such that movement of the tractive element is limited to rotation about an axle or steerably mounted to the frame to accomplish steering by pivoting the tractive element with respect to the frame.

Power machine 100 includes an operator station 150, which provides a position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e. from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote control device can be provided (i.e. remote from both of the power machine and any implement to which is it coupled) that is capable of controlling at least some of the operator controlled functions on the power machine.

FIGS. 2-3 illustrate an excavator 200, which is one particular example of a power machine of the type illustrated in FIG. 1, on which the disclosed embodiments can be employed. Unless specifically noted otherwise, embodiments disclosed below can be practiced on a variety of power machines, with the excavator 200 being only one of those power machines. Excavator 200 is described below for illustrative purposes. Not every excavator or power machine on which the illustrative embodiments can be practiced need have all of the features or be limited to the features that excavator 200 has. Excavator 200 has a frame 210 that supports and encloses a power system 220 (represented in FIGS. 2-3 as a block, as the actual power system is enclosed within the frame 210). The power system 220 includes electric battery packs that provide power to one or more electric motors. The one or more electric motors provide a power output to a hydraulic system and directly to tractive elements in some embodiments. The hydraulic system acts as a power conversion system that includes one or more hydraulic pumps for selectively providing pressurized hydraulic fluid to actuators that are operably coupled to work elements in response to signals provided by operator input devices. The hydraulic system also includes a control valve system that selectively provides pressurized hydraulic fluid to actuators in response to signals provided by operator input devices. The excavator 200 includes a plurality of work elements in the form of a first lift arm structure 230 and a second lift arm structure 330 (not all excavators have a second lift arm structure). In addition, excavator 200, being a work vehicle, includes a pair of tractive elements in the form of left and right track assemblies 240A and 240B, which are disposed on opposing sides of the frame 210.

An operator compartment 250 is defined in part by a cab 252, which is mounted on the frame 210. The cab 252 shown on excavator 200 is an enclosed structure, but other operator compartments need not be enclosed. For example, some excavators have a canopy that provides a roof but is not enclosed A control system, shown as block 260 is provided for controlling the various work elements. Control system 260 includes operator input devices, which interact with the power system 220 to selectively provide power signals to actuators to control work functions on the excavator 200.

Frame 210 includes an upper frame portion or house 211 that is pivotally mounted on a lower frame portion or undercarriage 212 via a swivel joint. The swivel joint includes a bearing, a ring gear, and a slew motor with a pinion gear (not pictured) that engages the ring gear to swivel the machine. The slew motor receives a power signal from the control system 260 to rotate the house 211 with respect to the undercarriage 212. House 211 is capable of unlimited rotation about a swivel axis 214 under power with respect to the undercarriage 212 in response to manipulation of an input device by an operator. Hydraulic conduits are fed through the swivel joint via a hydraulic swivel to provide pressurized hydraulic fluid to the tractive elements and one or more work elements such as lift arm 330 that are operably coupled to the undercarriage 212.

The first lift arm structure 230 is mounted to the house 211 via a swing mount 215. (Some excavators do not have a swing mount of the type described here.) The first lift arm structure 230 is a boom-arm lift arm of the type that is generally employed on excavators although certain features of this lift arm structure may be unique to the lift arm illustrated in FIGS. 2-3. The swing mount 215 includes a frame portion 215A and a lift arm portion 215B that is rotationally mounted to the frame portion 215A at a mounting frame pivot 231A. A swing actuator 233A is coupled to the house 211 and the lift arm portion 215B of the mount. Actuation of the swing actuator 233A causes the lift arm structure 230 to pivot or swing about an axis that extends longitudinally through the mounting frame pivot 231A.

The first lift arm structure 230 includes a first portion, known generally as a boom 232 and a second portion known as an arm or a dipper 234. The boom 232 is pivotally attached on a first end 232A to mount 215 at boom pivot mount 231B. A boom actuator 233B is attached to the mount 215 and the boom 232. Actuation of the boom actuator 233B causes the boom 232 to pivot about the boom pivot mount 231B, which effectively causes a second end 232B of the boom to be raised and lowered with respect to the house 211. A first end 234A of the arm 234 is pivotally attached to the second end 232B of the boom 232 at an arm mount pivot 231C. An arm actuator 233C is attached to the boom 232 and the arm 234. Actuation of the arm actuator 233C causes the arm to pivot about the arm mount pivot 231C. Each of the swing actuator 233A, the boom actuator 233B, and the arm actuator 233C can be independently controlled in response to control signals from operator input devices.

An exemplary implement interface 270 is provided at a second end 234B of the arm 234. The implement interface 270 includes an implement carrier 272 that is capable of accepting and securing a variety of different implements to the lift arm 230. Such implements have a machine interface that is configured to be engaged with the implement carrier 272. The implement carrier 272 is pivotally mounted to the second end 234B of the arm 234. An implement carrier actuator 233D is operably coupled to the arm 234 and a linkage assembly 276. The linkage assembly includes a first link 276A and a second link 276B. The first link 276A is pivotally mounted to the arm 234 and the implement carrier actuator 233D. The second link 276B is pivotally mounted to the implement carrier 272 and the first link 276A. The linkage assembly 276 is provided to allow the implement carrier 272 to pivot about the arm 234 when the implement carrier actuator 233D is actuated.

The implement interface 270 also includes an implement power source (not shown in FIGS. 2-3) available for connection to an implement on the lift arm structure 230 or 234. In some exemplary embodiments, the implement power source includes a pressurized hydraulic fluid port to which an implement can be coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The electrical power source can also include electrical conduits that are in communication with a data bus on the excavator 200 to allow communication between a controller on an implement and electronic devices on the excavator 200.

The lower frame 212 supports and has attached to it a pair of tractive elements 240, identified in FIGS. 2-3 as left track drive assembly 240A and right track drive assembly 240B. Each of the tractive elements 240 has a track frame 242 that is coupled to the lower frame 212. The track frame 242 supports and is surrounded by an endless track 244, which rotates under power to propel the excavator 200 over a support surface. Various elements are coupled to or otherwise supported by the track 242 for engaging and supporting the track 244 and cause it to rotate about the track frame. For example, a sprocket 246 is supported by the track frame 242 and engages the endless track 244 to cause the endless track to rotate about the track frame. An idler 245 is held against the track 244 by a tensioner (not shown) to maintain proper tension on the track. The track frame 242 also supports a plurality of rollers 248, which engage the track and, through the track, the support surface to support and distribute the weight of the excavator 200. An upper track guide 249 is provided for providing tension on track 244 and prevent the track from rubbing on track frame 242.

A second or lower lift arm 330 is pivotally attached to the lower frame 212. A lower lift arm actuator 332 is pivotally coupled to the lower frame 212 at a first end 332A and to the lower lift arm 330 at a second end 332B. The lower lift arm 330 is configured to carry a lower implement 334. The lower implement 334 can be rigidly fixed to the lower lift arm 330 such that it is integral to the lift arm. Alternatively, the lower implement can be pivotally attached to the lower lift arm via an implement interface, which in some embodiments can include an implement carrier of the type described above. Lower lift arms with implement interfaces can accept and secure various different types of implements thereto. Actuation of the lower lift arm actuator 332, in response to operator input, causes the lower lift arm 330 to pivot with respect to the lower frame 212, thereby raising and lowering the lower implement 334.

Upper frame portion 211 supports cab 252, which defines, at least in part, operator compartment or station 250. A seat 254 is provided within cab 252 in which an operator can be seated while operating the excavator. While sitting in the seat 254, an operator will have access to a plurality of operator input devices 256 that the operator can manipulate to control various work functions, such as manipulating the lift arm 230, the lower lift arm 330, the traction system 240, pivoting the house 211, the tractive elements 240, and so forth.

Excavator 200 provides a variety of different operator input devices 256 to control various functions. For example, in exemplary embodiments, hydraulic or electric joysticks are provided to control the lift arm 230, and swiveling of the house 211 of the excavator. Also in exemplary embodiments, foot pedals with attached levers are provided for controlling travel and lift arm swing. Electrical switches are frequently included and located on the joysticks for controlling the providing of power to an implement attached to the implement carrier 272. Other types of operator inputs that can be used in excavator 200 and other excavators and power machines include, but are not limited to, switches, buttons, knobs, levers, variable sliders and the like. The specific control examples provided above are exemplary in nature and not intended to describe the input devices for all excavators and what they control.

Display devices are provided in the cab to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

The description of power machine 100 and excavator 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on an excavator such as excavator 200, unless otherwise noted, the concepts discussed below are not intended to be limited in their application to the environments specifically described above.

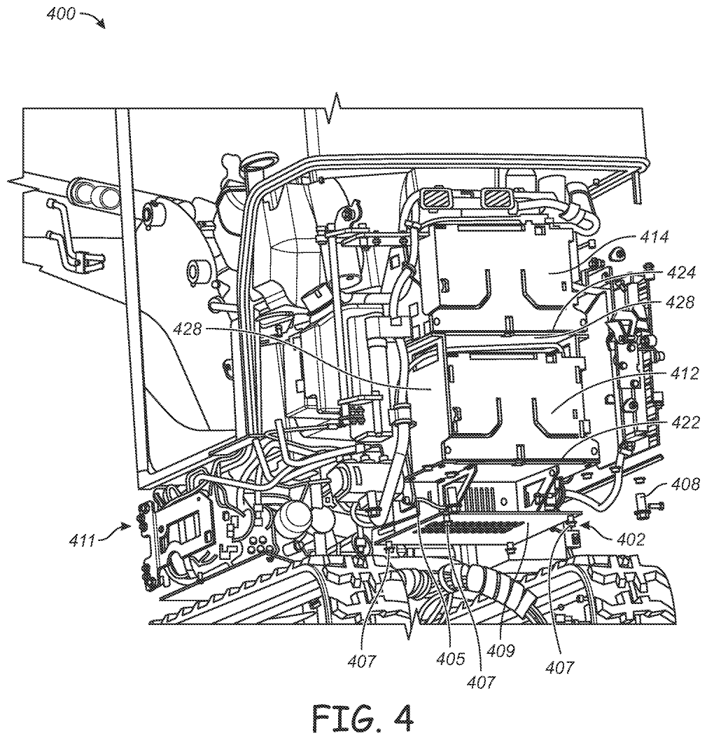

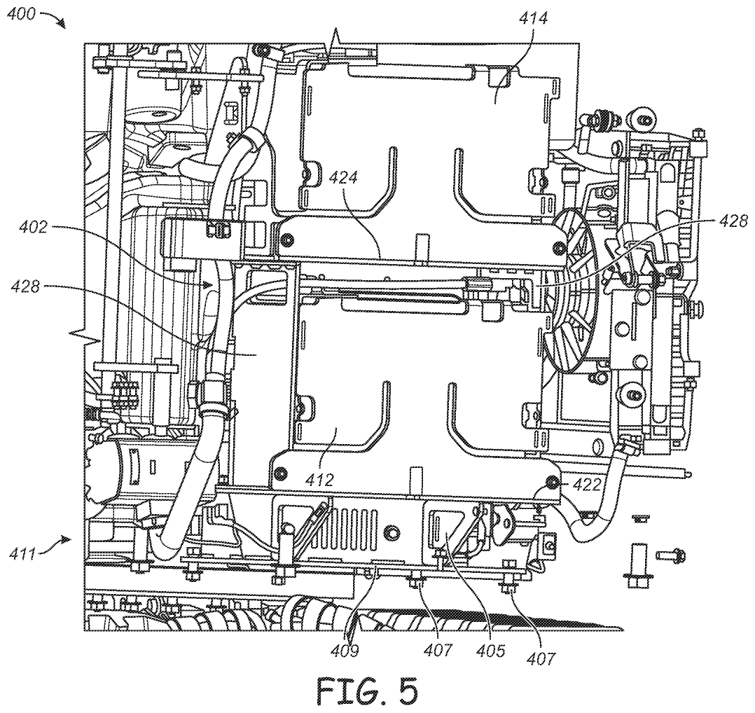

Referring now to FIGS. 4 and 5, shown are rear perspective views of a partially assembled excavator 400 which is an example embodiment of excavator 200 and power machine 100 discussed above. Portions of the excavator 400 are removed to better illustrate aspects of disclosed embodiments. However, in exemplary embodiments, excavator 400 includes some or all of the above-discussed components even if not illustrated in FIGS. 4-5 and related figures. Excavator 400 includes a bracket assembly 402 secured to, or formed as a portion of, an upper frame portion 411 of an excavator frame. The bracket assembly 402 is a battery pack support structure and is secured to the upper frame portion 411 using fasteners 407, or by other mounting techniques such as welding. Also shown are fasteners 408 which are used to secure a counterweight (not shown) to the upper frame portion. Bracket assembly 402 includes a bracket 405 and bracket expansion plates 428. Bracket expansion plates 428 are mounted on, or mountable to, bracket 405 to configure the bracket assembly 402 to support three batteries or battery packs. In alternative embodiments, instead of being separate components, the structure provided by bracket expansion plates 428 can be integrally formed with other portions of bracket 405. In some exemplary embodiments, bracket 405 of bracket assembly 402 includes a base plate 409 through which at least some of the fasteners 407 extend to secure the bracket to the upper frame portion 411. Some of the upper frame portion 411 is omitted from FIG. 4 to better illustrate bracket assembly 402. The illustrated configuration of bracket assembly 402 supports at least first, second and third battery packs, as well as an electric motor, in a physical arrangement which facilitates the ability to house the battery packs, electric motor and other supporting components within the constraints of limited available space with a conventional excavator component configuration.

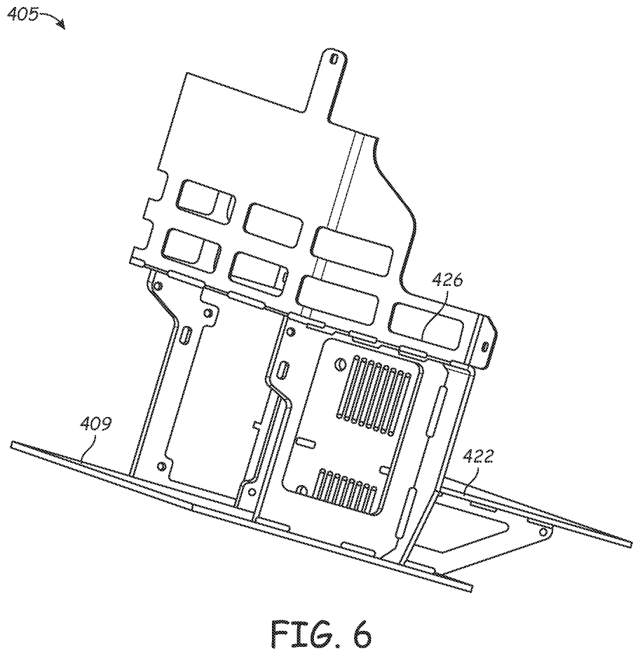

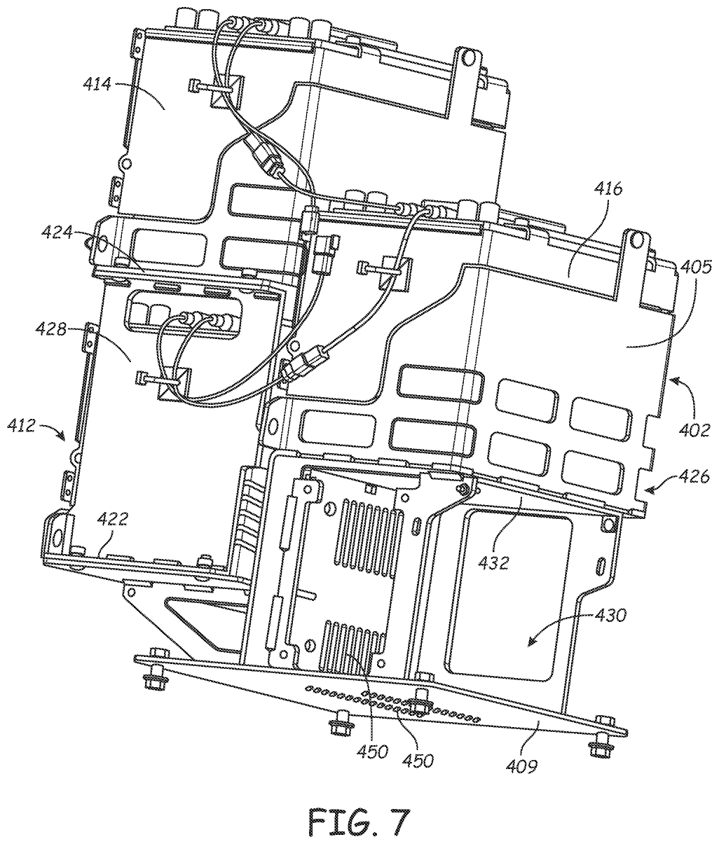

To optimize the positioning of the battery packs, the electric motor, and related electric components, bracket assembly 402 is configured to implement a staggered design which positions battery packs at three different vertical levels, and at two different positions in a longitudinal (back-to-front) direction of the excavator. FIG. 6 shows bracket 405 of bracket assembly 402 alone, separate from other components of the excavator and without bracket expansion plates 428 or mounted battery packs. FIG. 7 illustrates bracket assembly 402 with battery packs 412, 414 and 416 mounted on the bracket assembly. It must be noted that although FIG. 7 illustrates battery packs mounted on bracket assembly 402 without illustration of other excavator components, due to the combined weight of the battery packs and bracket assembly, battery packs 412, 414 and 416 may in some assembly embodiments be positioned on the bracket assembly after the bracket assembly is secured to upper frame portion 411 of an excavator.

As shown in FIGS. 4-5 and 7, bracket assembly 402 is configured to provide a first battery support surface 422 and a second battery support surface 424 at a rear portion of the bracket. In exemplary embodiments, the first battery support surface 422 is provided by the bracket 405, while the second battery support surface 424 is supported by the bracket expansion plates 428. The bracket assembly 402 and support surfaces 422 and 424 are configured to mount a first battery pack 412 and a second battery pack 414, one directly above the other. The bracket 405 of bracket assembly 402 also provides a third battery support surface 426 which is offset vertically from surfaces 422 and 424, and which is laterally forward of the first and second surfaces 422 and 426. The bracket 405 and support surface 426 are configured to mount a third battery pack 416 forward of battery packs 412 and 414. Battery support surface 422 is elevated relative to base plate 409 in order to raise the corresponding battery pack 412 above the bottom of the upper frame structure thereby preventing an interference between the battery packs and an excavator counterweight, and also to enhance airflow around the batteries.

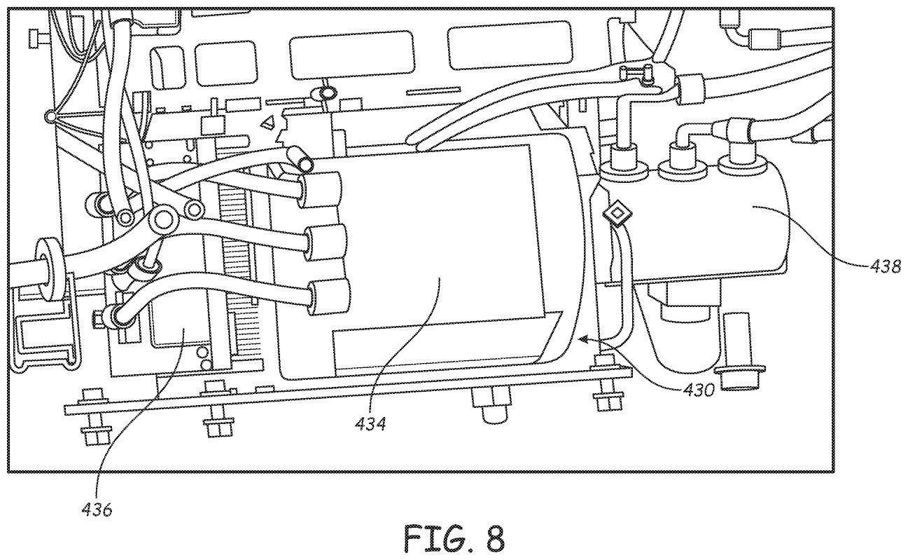

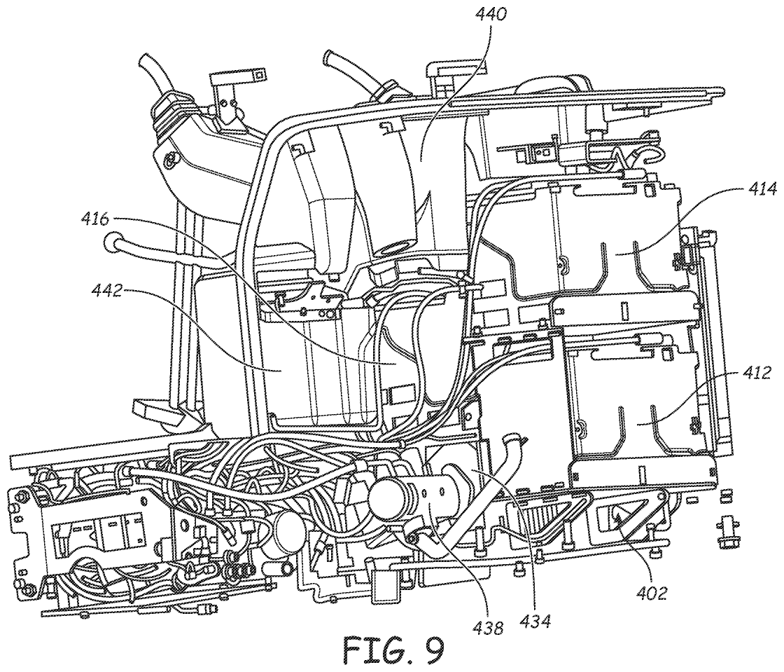

As shown best in FIG. 7, bracket assembly 402 provides an electric motor mount 430 in the space beneath battery support surface 426 and base plate 409. A heat shield plate 432 is in an example embodiment positioned between or connected to battery support surface 426. In this position, the heat shield can improve stiffness of the support surface. The heat shield is in an exemplary embodiment made of commonly available steel, such as steel MS252, which is cooled by the airflow between it and the surface 426. In other embodiments, the heat shield plate 432 is made of a thermally insulating material to deflect heat from the motor and inverter and thereby limit the heat transfer to front battery pack 416. FIG. 8 illustrates electric motor 434 and inverter 436 mounted within electric motor mount 430 of bracket assembly 402. As shown in FIGS. 8-9, a hydraulic pump or pump package 438 is mounted to a side of electric motor 434. Electric motor 434 provides a rotary shaft output, or alternatively a rotary shaft receiving receptacle, which drives the hydraulic pump 438 and thereby powers the hydraulic system of excavator 400. As can be seen in FIG. 9, the forward battery pack 416, which is the master battery in in exemplary embodiment, is positioned by bracket assembly 402 beneath operator seat bonnet 440, and behind tool box 442.

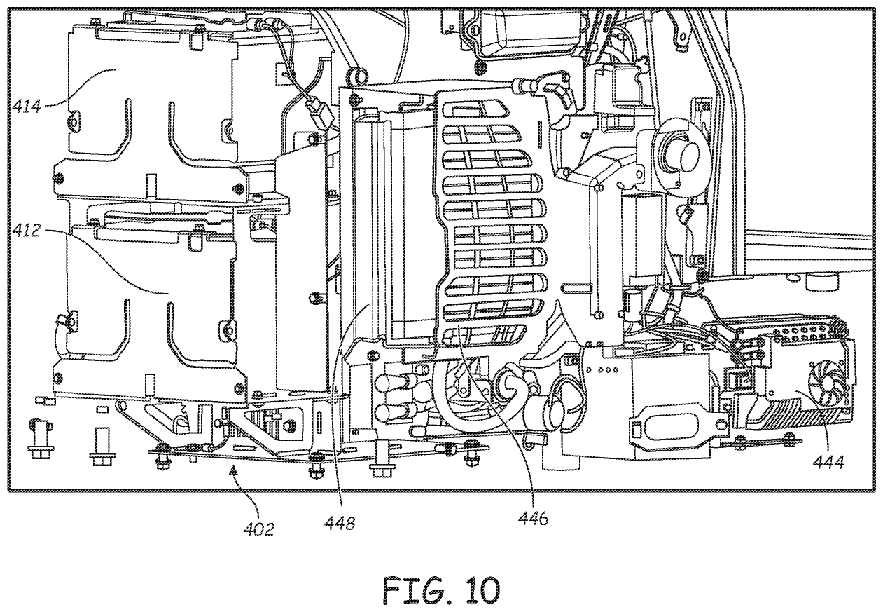

Referring now to FIG. 10, shown are portions of excavator 400 illustrating a location of a charger for the battery packs discussed above. As shown, charger 444 is positioned on the right side of the excavator opposite a left side housing the hydraulic pump package 438. The charger 444 is positioned, in some exemplary embodiments, under the space for an operator's legs when operating the machine. As an example, charger 444 can be a 1.3 kW charger, but chargers with other power ratings or multiple chargers can be used instead.

FIG. 10 also shows the positioning of heat exchanger 446 and corresponding fan 448 on the right side of the machine adjacent to, and overlapping lengthwise with, the bracket assembly 402 and both rear batteries 412 and 414. The fan 448 moves air through heat exchanger 446 to cool the hydraulic system and to move air through the upper structure. The bracket assembly facilitates cooling by virtue of the battery pack positioning and spacing which facilitates airflow past the battery packs, electric motor, inverter, charger and other electrical components. To further facilitate airflow, in some specific embodiments, baseplate 409 and other portions of the bracket assembly 402 may include air vents 450 (shown in FIG. 7) to supplement airflow through the bracket assembly and electrical components and to aid in further cooling these components.

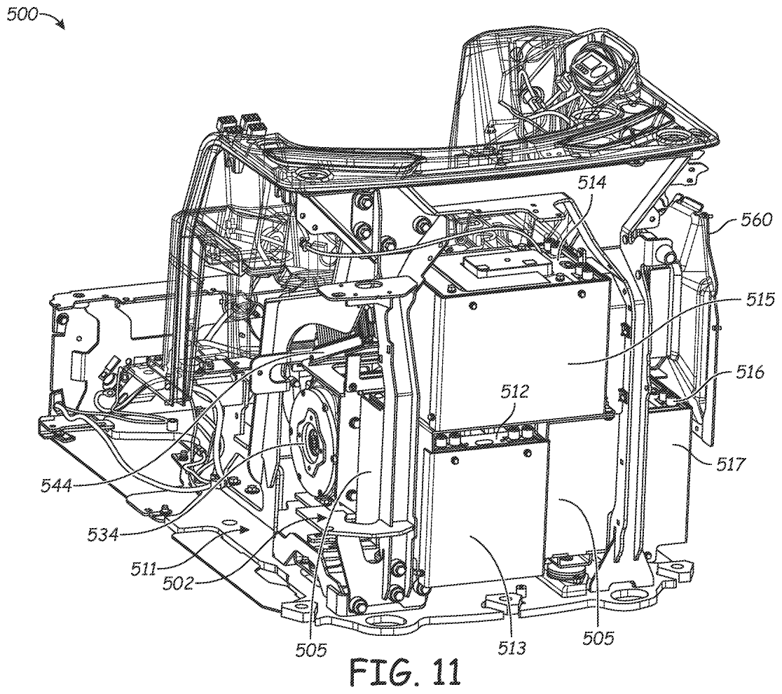

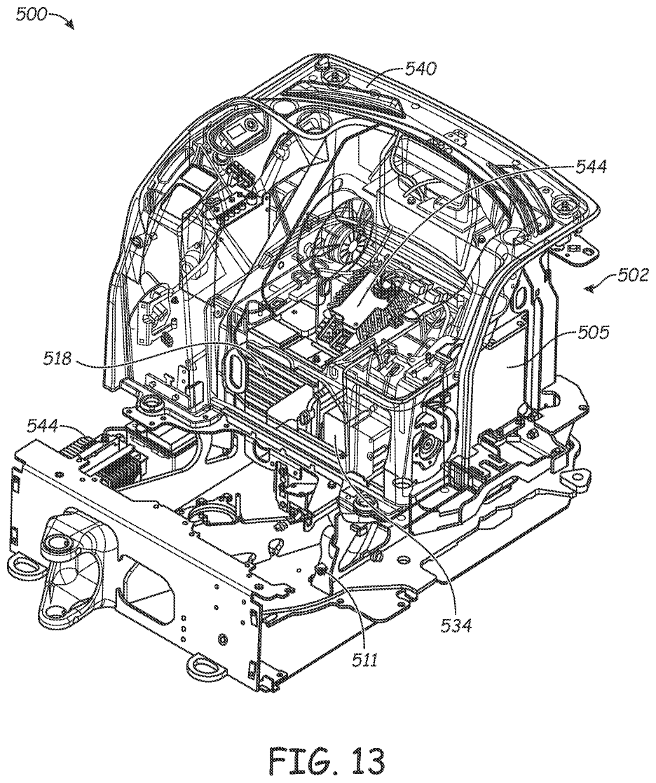

Referring now to FIGS. 11-13, shown are rear and front perspective views of portions of a partial upper structure of an excavator 500 which is another example embodiment of excavator 200 and power machine 100 discussed above. Other portions of the excavator 500 are removed to better illustrate aspects of disclosed embodiments. Excavator 500 includes a battery pack support structure or bracket assembly 502 secured to, or formed as a portion of, an upper frame portion 511 of an excavator frame. Bracket assembly 502 includes a bracket 505 configured to support at least three batteries or battery packs. The illustrated configuration of bracket assembly 502 supports at least first, second and third battery packs, as well as an electric motor, electric chargers and an inverter in a physical arrangement which facilitates the ability to house the battery packs, electric motor and other supporting components within the space constraints of a conventional excavator component configuration.

In exemplary embodiments, bracket 505 is configured to mount four battery packs, including two battery packs 512 and 514 stacked vertically and positioned rearward of an electric motor 534, and two battery packs 516 and 518 positioned on a right-hand side of the excavator laterally offset from the electric motor. Battery packs 514, 516 and 518 are all oriented with their longitudinal axes or directions, or directions of their widest dimensions in parallel horizontal planes, extending laterally across the excavator. However, battery pack 512 is oriented off-axis with its longitudinal direction extending in the longitudinal direction (back-to-front) of the excavator. Battery covers 513, 515 and 517 are securable to the battery packs or to the bracket 505 to provide protection for the battery packs or to assist in securing the battery packs in their mounted positions.

To optimize the positioning of the battery packs, the electric motor, and related electric components, bracket assembly 502 is configured to implement a design which positions battery packs at two different vertical levels, and on two sides of the electric motor 534. As discussed, the rear battery packs 512 and 514 are positioned rearward of the electric motor in a longitudinal (front-to-back) direction of the excavator, but longitudinally in orthogonal directions to one another. Battery packs 516 and 518 are positioned at the same vertical level as battery pack 512, but on a side of the electric motor. Battery pack 516 is also positioned rearward of the electric motor. This configuration allows four separate large size 48V battery packs, the electric motor 534, and other electric components to all be positioned within the engine compartment of a conventional engine driven excavator. In some exemplary embodiments, battery packs 516 and 518 can be replaced by a single larger battery. Therefore, battery packs 516 and 518 should be considered to be one or more batteries in the configuration described above.

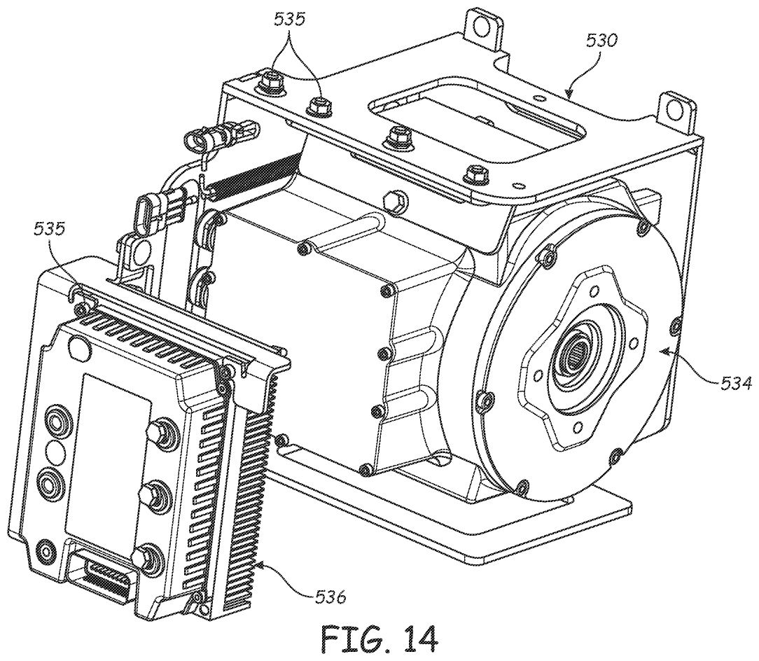

Referring for now also to FIG. 14, shown is an electric motor mount or support structure 530 to which the electric motor 534 and inverter 536 are mounted using fasteners 535 or by other mechanisms or processes. Support structure 530 is then mounted to bracket 505 or to the upper frame assembly 511.

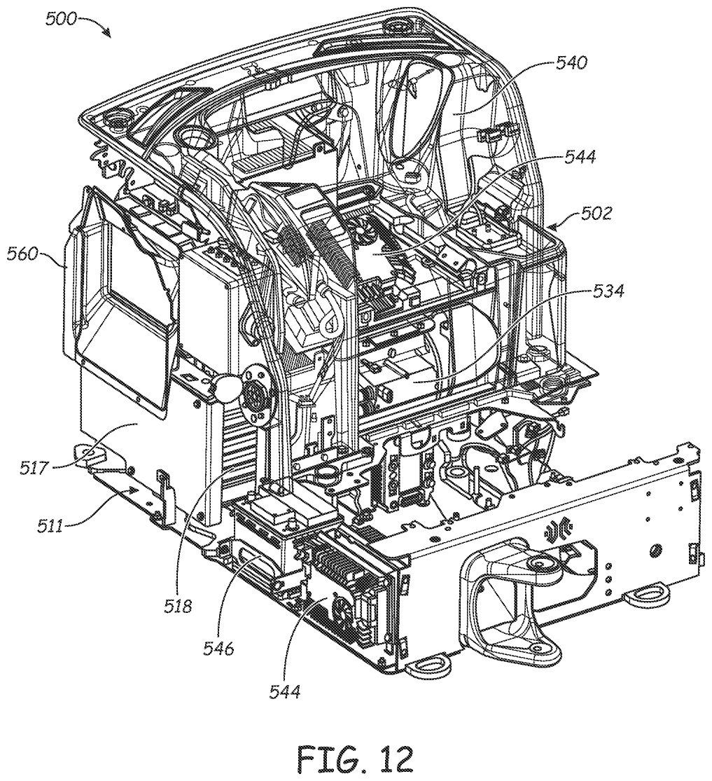

In exemplary embodiments, and as shown in at least FIG. 12, one or more electric chargers 544 are positioned above electric motor 534 and under the operator seat bonnet 540. One or more additional electric chargers 544 and a 12 Volt battery 546 are positioned on the right side of the excavator forward of the operator seat adjacent one another.

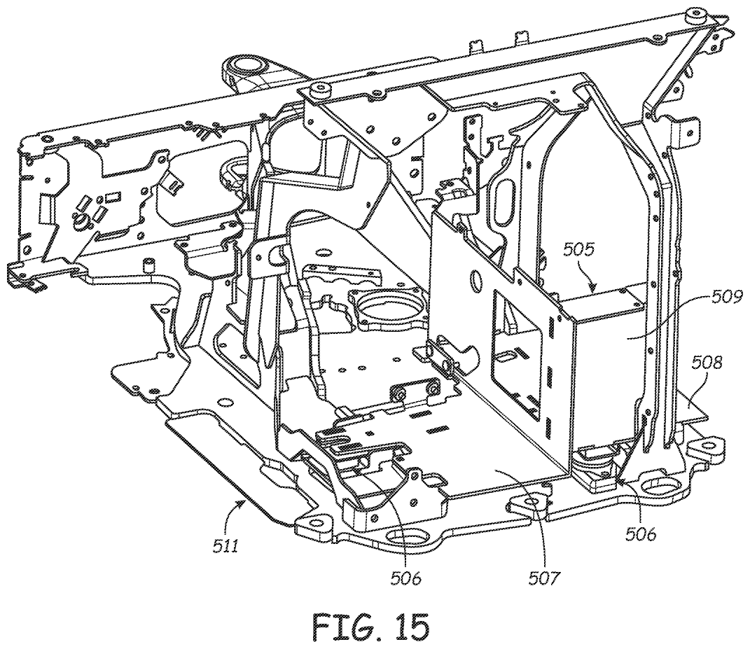

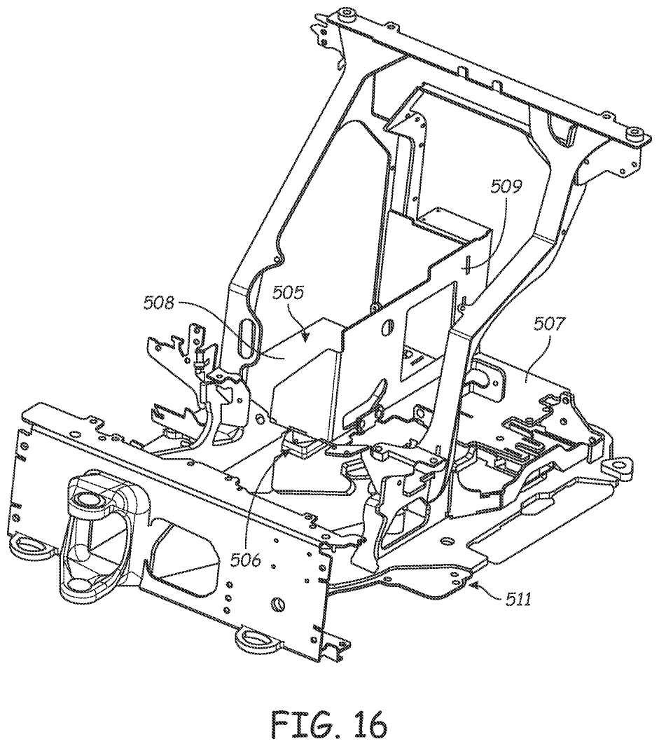

FIGS. 15-16 illustrate portions of bracket 505 of bracket assembly 502 without the battery packs, electric motor, chargers and other electric components. Bracket 505 is mounted to upper frame assembly 511 using rubber mounts 506 to dampen vibration transfer from upper frame assembly to bracket 505. As can be seen, bracket 505 includes battery support surfaces 507 and 508, and wall sections 509. The battery support surfaces and wall sections support the battery packs, with battery pack 512 positionable on battery support surface 507, and battery packs 516 and 518 positionable on battery support surface 508.

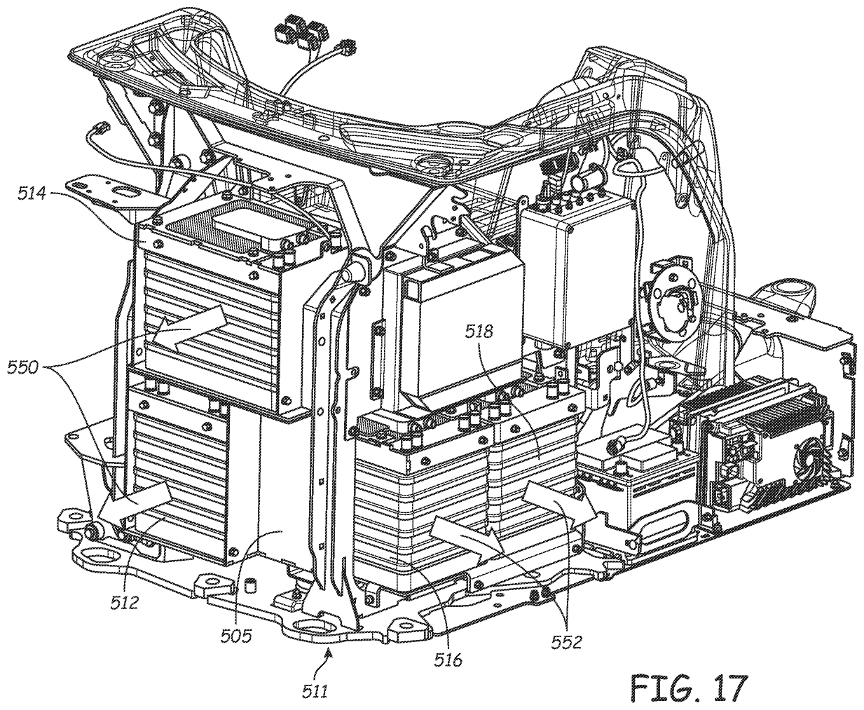

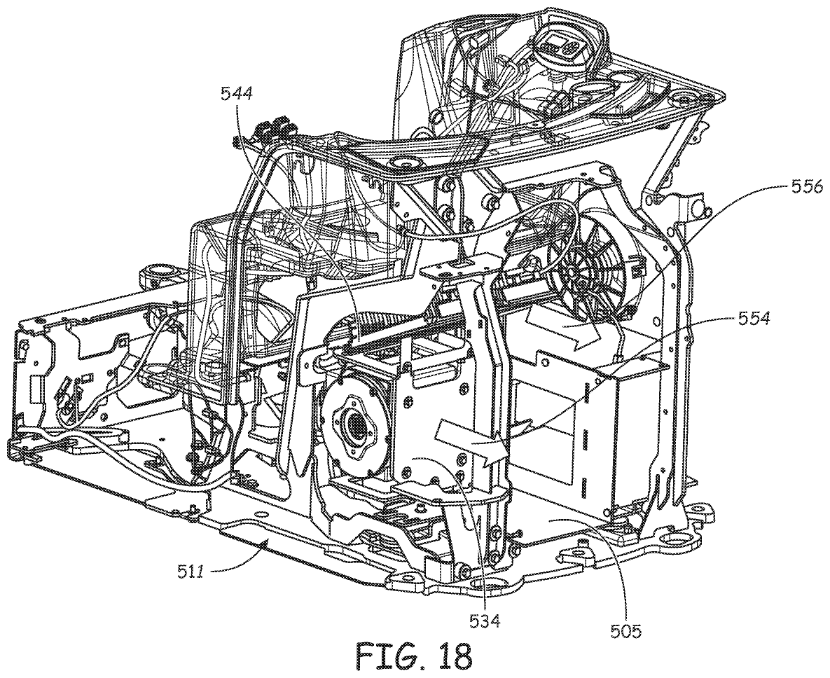

FIGS. 17 and 18 illustrate directions of component removal from upper frame assembly and bracket 502 in some exemplary embodiments. As shown in FIG. 17, with covers 513, 515 and 517 removed, battery packs 512 and 514 can be removed in the longitudinal direction of the excavator as represented by arrows 550. Side batteries 516 and 518 can be removed in the lateral direction of the excavator as represented by arrows 552. Insertion of the battery packs is performed in the directions opposite those shown by arrows 550 and 552. By configuring the bracket 505 to insert and remove battery packs from two different orthogonal directions, the battery packs can be fit into the space available in conventional excavator upper house structures (and utilizing existing engine hatches for access). After removal of the battery packs as shown in FIG. 17, the electric motor 534 and the charger 544 positioned above the electric motor can be removed in the longitudinal directions represented by arrows 554 and 556.

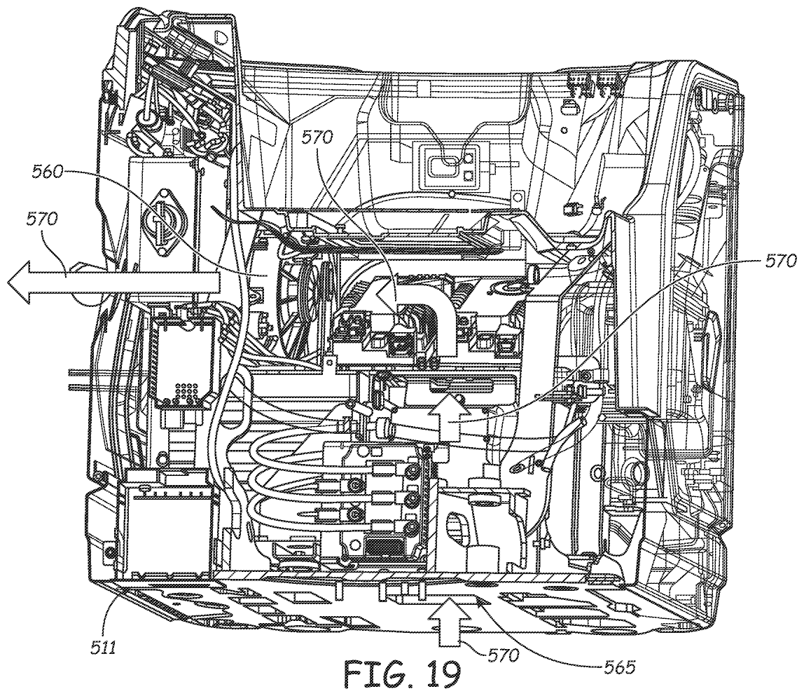

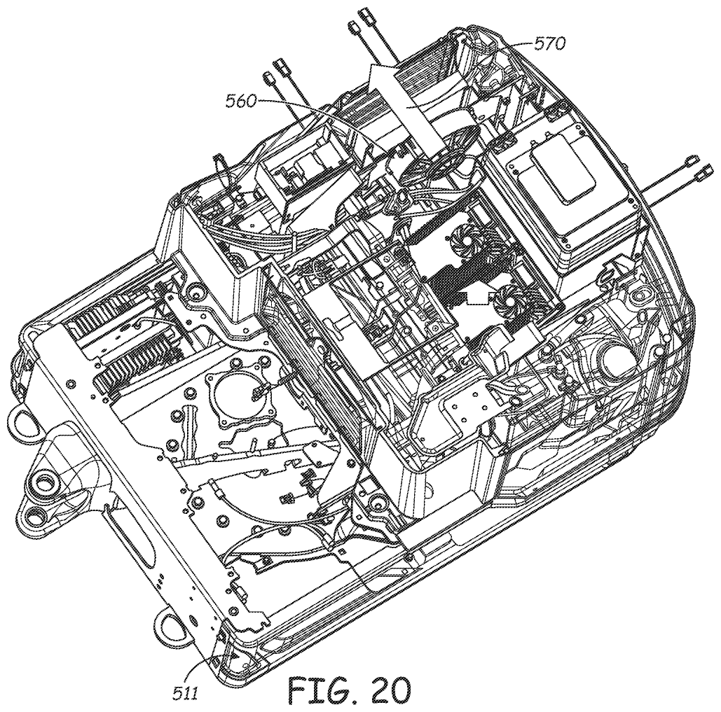

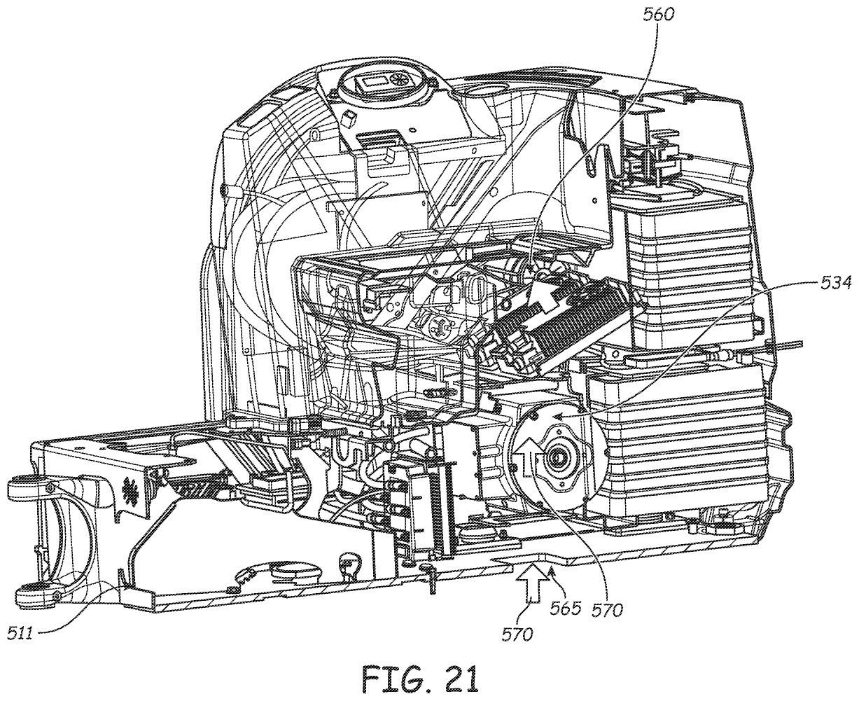

FIGS. 11 and 12 also illustrate a cooling package 560 on excavator 500 having a heat exchanger and a cooling fan similar to those discussed above with reference to FIG. 10 and excavator 400. The cooling fan moves air through the heat exchanger to cool the hydraulic system. While actively cooling the hydraulic system using cooling package 560, with the active cooling also benefitting the battery packs, electric motor and other electric components, excavator 500 also implements features which facilitate passive cooling when the cooling fan is not operating. The upper frame portion 511 and bracket 505 are configured to guide air flow for cooling the battery packs and other components by providing a pathway within the frame and bracket design. As illustrated in FIGS. 19-21, an air intake hole 565 on the bottom of upper frame portion 511 allows air to be actively sucked upward through a channel passing near the battery packs, chargers and electric motor to cool these key components. Airflow through the channel is represented in FIGS. 19-21 by arrows 570. When the excavator is running and the hydraulic cooling package 560 is operational, the cooling fan creates an intentional airflow through the channel which also cools the electric components. However, when the excavator is not running, but battery components such as the battery chargers are operating, this design provides passive cooling via a convection current through the same cooling channel.

Although the present invention has been described with reference to preferred embodiments, workers skilled in the art will recognize that changes may be made in form and detail without departing from the scope of the discussion.

What is claimed is:

1. A power machine comprising:
a frame having a lower frame portion and an upper frame portion which swivels relative to the lower frame portion.
a lift arm structure pivotally coupled to the upper frame portion such that the lift arm structure can be raised and lowered;
a hydraulic pump configured to provide pressurized hydraulic fluid to one or more hydraulic actuators on the power machine;
an electric motor coupled to the hydraulic pump and configured to power the hydraulic pump;
a plurality of battery packs configured to provide electric power to the power machine; and
a battery pack support structure mounted on the upper frame portion of the power machine frame, the battery pack support structure providing battery support surfaces, including first, second and third battery support surfaces, configured to mount at least first, second and third battery packs of the plurality of battery packs in a vertically and horizontally staggered configuration, the first battery pack positioned on the first battery support surface at a first vertical level, the second battery pack positioned on the second battery support surface at a second vertical level above the first battery pack, and the third battery pack positioned on the third battery support surface at a third vertical level above the first battery support surface and below the second battery support surface.

2. The power machine of claim 1, wherein the battery pack support structure provides an electric motor mount beneath the third battery support surface, wherein with the electric motor of the power machine mounted on the electric motor mount, the first battery pack is positioned rearward of the electric motor on the first battery support surface at the first level, the second battery pack is positioned rearward of the electric motor on the second battery support surface at the second level, and the third battery pack is positioned above the electric motor on the third battery support surface at the third level.

3. The power machine of claim 1, wherein the battery pack support structure provides a heat shield between the third battery pack and the electric motor.

4. The power machine of claim 1, wherein the hydraulic pump is mounted on a first side of the electric motor.

5. The power machine of claim 4, and further comprising an operator seat bonnet, wherein the battery pack support structure is configured to mount the third battery beneath the operator seat bonnet.

6. The power machine of claim 4, and further comprising a charger positioned on a second side of the electric motor and configured to charge the battery packs.

7. The power machine of claim 1, and further comprising a hydraulic system cooling fan, wherein the battery pack support structure includes vents and is configured to cool the battery packs with airflow through the vents, including airflow from the hydraulic system cooling fan.

8. A power machine comprising:
a frame having a lower frame portion and an upper frame portion which swivels relative to the lower frame portion.
a lift arm structure pivotally coupled to the upper frame portion such that the lift arm structure can be raised and lowered;
a hydraulic pump configured to provide pressurized hydraulic fluid to one or more hydraulic actuators on the power machine;
an electric motor coupled to the hydraulic pump and configured to power the hydraulic pump;
a plurality of battery packs configured to provide electric power to the power machine; and
a battery pack support structure on the upper frame portion of the power machine frame, wherein the battery pack support structure is configured to mount at least first, second, and third battery packs of the plurality of battery packs in a configuration around the electric motor with the first battery pack positioned at a rear of the upper frame portion at a first vertical level and rearward of the electric motor, the second battery pack positioned at a rear of the upper frame portion at a second vertical level above the first battery pack and rearward of the electric motor, and the third battery pack positioned on a first side of the upper frame portion such that the first and third battery packs wrap from rearward of the electric motor to the side of the electric motor.

9. The power machine of claim 8, wherein the battery pack support structure is configured such that the first battery pack extends longitudinally in a direction from the rear of the upper frame portion toward a front of the upper frame portion, an such that the second and third battery packs extend longitudinally in directions from a first side of the upper frame portion to a second side of the upper frame portion.

10. The power machine of claim 9, wherein the battery pack support structure is configured to mount a fourth battery pack of the plurality of battery packs such that the fourth battery pack is positioned on the first side of the upper frame portion forward of the third battery pack and such that the first, third and fourth battery packs wrap from rearward of the electric motor to the side of the electric motor.

11. The power machine of claim 10, wherein the battery pack support structure is configured such that the second, third and fourth battery packs extend longitudinally in the directions from the first side of the upper frame portion to the second side of the upper frame portion.

12. The power machine of claim 11, and further comprising a first charger positioned above the electric motor and configured to charge the plurality of battery packs.

13. The power machine of claim 12, and further comprising a second charger positioned on the first side of the upper frame portion forward of the third and fourth battery packs and under a space for an operator's feet when operating the power machine.

14. The power machine of claim 13, and further comprising a 12-volt battery positioned on the first side of the upper frame portion between the fourth battery and the second charger.

15. The power machine of claim 12, and further comprising an inverter and an electric motor mount, wherein the electric motor and inverter are mounted on the electric motor mount and the electric motor mount is mounted to the battery pack support structure or to the upper frame portion.

16. The power machine of claim 12, and further comprising an operator seat bonnet, wherein the electric motor and first charger are positioned beneath the operator seat bonnet.

17. The power machine of claim 11, and further comprising a hydraulic system cooling fan, wherein the upper frame portion and the battery pack support structure are configured to guide air flow for cooling the plurality of battery packs and other components by providing an air pathway within the upper frame portion and battery pack support structure.

18. The power machine of claim 17, wherein the air pathway extends from an air intake aperture on a bottom of the upper frame portion and through a channel passing adjacent the plurality of battery packs.
